(19) United States
(12) Patent Application Publication
(10) Pub. No.: US 2003/0032706 A1
(43) Pub. Date: Feb. 13, 2003

(54) Protective polyvinylpyrrolidone liquid masking compounds and related methods

(76) Inventors: Sally J. Blaine, North Canton, OH (US); Roy A. Leckonby, Uniontown, OH (US)

Correspondence Address: RENNER, KENNER, GREIVE, BOBAK, TAYLOR & WEBER, FOURTH FLOOR, FIRST NATIONAL TOWER, AKRON, OH, 44308, US

(21) Appl. No.: 09/854,315

(22) Filed: May 10, 2001

(51) Int. Cl. B05D 1/00; B05D 1/32; C08K 5/05

(52) U.S. Cl. 524/386; 427/282

(57) ABSTRACT

A liquid masking composition comprises from about 2 to about 50 percent by weight of polyvinylpyrrolidone, a water soluble plasticizer at a polyvinylpyrrolidone to plasticizer ratio of between about 0.5 to 1 to about 5 to 1, from 0 to about 8 percent by weight of at least one surfactant, from 0 to less than 16 percent by weight of a saccharide; and sufficient water to total 100 percent by weight. A method for protecting selected surfaces from paint in painting operations comprises applying a liquid masking composition of the present invention to selected surfaces of an object where paint subsequently applied is not desired; allowing the liquid masking composition to dry, forming a film; painting the object, whereby surfaces carrying the film are protected from the application of paint; and removing the film. A method for protecting motor vehicles or other goods from dirt, oil, grease, or other deposits is similarly disclosed.

### BACKGROUND OF THE INVENTION

This invention relates to protective coating materials which are applicable to surfaces in liquid form, which quickly dry and which can subsequently be removed by washing with water. Their principal utility is to protect painted surfaces by acting as a mask so that in operations such as painting, areas covered by this coating do not become painted. Although the mask may receive some paint, when it is removed, the underlying surface is then clean and paint-free. Such coatings are generally applied to vehicles in lieu of applying masking paper which is a time-consuming operation. The coating would also have utility in the transport of goods in open containers, such as new cars or related vehicles. Because these vehicles are stacked for movement via truck or rail, it is customary to apply a protective layer of plastic to protect the finish of underlying vehicles from oil and grease deposits as well as other dirt and grime received during transportation.

Liquid masking compounds are not new. The principal ingredient thereof is a water-washable polymer material that is formulated and applicable as a liquid and which readily dries to form a polymeric film. The film should not have a great affinity for the underlying surface so that it can readily be removed when desired by washing to remove the film. Any paint or other contaminant which has adhered to the film is removed with the film.

The patent literature includes films of this type. U.S. Pat. No. 5,618,578, for instance, owned by the Assignee of record, discloses a solvent free liquid masking composition that comprises an aliphatic polyol such as polyvinyl alcohol, a plasticizer, a surfactant and water. The compositions of this patent are devoid of volatile organic compounds.

U.S. Pat. No. 5,186,978 is directed toward a liquid masking compound which comprises water, an aliphatic polyol such as polyvinyl alcohol, an alcohol and a surfactant. Also disclosed is a method for protecting various surfaces utilizing the disclosed masking compound.

U.S. Pat. No. 5,183,688 discloses a so-called water-based resist material which comprises water, polyvinyl alcohol, isopropyl alcohol, a surfactant and cornstarch. This resist material is used in conjunction with applying advertising messages onto convex acrylic mirrored surfaces.

U.S. Pat. No. 5,027,597 is directed toward a temporary protective coating comprising a water-soluble polymeric film and insoluble inert particles such as polyethylene and acrylic beads which act as spacers. Such coatings are applied to glass and polymeric sheet surfaces and the beads act as spacers when the sheets are stacked.

U.S. Pat. No. 4,222,922 is directed toward a warp size composition for polyester filaments which comprises polyvinyl alcohol, a cationic surfactant and a polyhydric alcohol plasticizer, such as glycerol.

It is known that polyvinylpyrrolidone (PVP) will form a water-resoluble film when applied to a surface. It is generally considered to be unsuitable as a film-former in paint masking operations, however, because of its solubility in a variety of organic solvents, including those used in the painting of goods such as automobiles. Solubility in such organic solvents is especially pronounced for lower molecular weight PVP's.

A masking composition containing polyvinylpyrrolidone is disclosed in U.S. Pat. No. 4,548,967. This masking composition, however, is based not only on polyvinylpyrrolidone, but also on one or more saccharides. The presence of saccharides, however, makes the masking composition susceptible to degradation by microorganisms. This can make the addition of antimicrobial compounds necessary for the composition to have a satisfactory shelf-life.

While attempts have been made heretofore to formulate liquid masking compounds and protective coatings for a variety of purposes, the art has not provided a satisfactory water-washable liquid masking composition comprising a polyvinylpyrrolidone and less than 16 percent by weight saccharide for use as a paint-masking composition or for other purposes where it is desirable to apply the film as a liquid and subsequently remove the dried film by washing.

### BRIEF SUMMARY OF THE INVENTION

It is therefore, an aspect of the present invention to provide a liquid masking composition which is based upon a water-washable film-forming polyvinylpyrrolidone polymer, containing less than 16 percent saccharide.

It is another aspect of the present invention to provide a liquid masking composition that is not harmful to the environment.

It is yet another aspect of the present invention to provide a liquid masking composition that is readily applied to surfaces; sets quickly to a dry, slightly tacky film; can withstand baking in paint booths up to about 150° F. (66° C.) without baking hard; and is subsequently readily removable from the surfaces to which it is applied.

It is still another aspect to provide a method for protecting surfaces with a water-washable polymeric film.

At least one or more of the foregoing aspects, together with the advantages thereof over the known art relating to liquid protective coating compositions, which shall become apparent from the specification which follows, are accomplished by the invention as hereinafter described and claimed.

In general, the present invention provides a liquid masking composition comprising from about 2 to about 50 percent by weight of polyvinylpyrrolidone; a water soluble plasticizer at a polyvinylpyrrolidone to plasticizer ratio of between about 0.5 to 1 to about 5 to 1; from 0 to about 8 percent by weight of at least one surfactant; from 0 to less than 16 percent by weight of a saccharide; and sufficient water to total 100 percent by weight.

The present invention also includes a method for protecting selected surfaces from paint in painting operations comprising applying a liquid composition to selected surfaces of an object where paint subsequently applied is not desired; allowing said liquid masking composition to dry, forming a film; painting said object, whereby surfaces carrying said film are protected from the application of paint and removing said film, wherein the liquid masking composition comprises from about 2 to about 50 percent by weight of polyvinylpyrrolidone; a water soluble plasticizer at a polyvinylpyrrolidone to plasticizer ratio of between about 0.5 to 1 to about 5 to 1; from 0 to about 8 percent by weight of at least one surfactant; from 0 to less than 16 percent by weight of a saccharide; and sufficient water to total 100 percent by weight.

The present invention similarly includes a method for protecting selected surfaces of goods from the deposition of dirt, oil, grease, air pollutants, acid rain, vehicle exhaust, soot, rubber or asphalt pieces, road tar, or other contaminants comprising applying a liquid masking composition to selected surfaces of a good to be protected; allowing said liquid masking composition to dry, forming a film; exposing said object to potential contamination, whereby surfaces carrying said film are protected from the deposition of dirt, oil, grease, air pollutants, acid rain, vehicle exhaust, soot, rubber or asphalt pieces, road tar, or other contaminants; and removing said film, wherein said liquid masking composition comprises from about 2 to about 50 percent by weight of polyvinylpyrrolidone, a water soluble plasticizer at a polyvinylpyrrolidone to plasticizer ratio of between about 0.5 to 1 to about 5 to 1, from 0 to about 8 percent by weight of at least one surfactant, from 0 to less than 16 percent by weight of a saccharide, and sufficient water to total 100 percent by weight.

It is envisioned that this method would be useful for the transportation of any goods which may be subject to contamination by grease, dirt, oil, soot, road tar, asphalt, air pollution, vehicle exhaust, acid rain, or other material which may mar or otherwise damage the surface of the goods. It is envisioned that the method of the present invention would be particularly useful in the transportation of goods in open containers, such as automobiles or similar vehicles by rail or truck.

The examples herein are intended to be illustrative only. Therefore, the methods of the present invention should not be construed as being limited to only these examples.

### DETAILED DESCRIPTION OF THE INVENTION

The present invention provides an environmentally acceptable liquid composition for masking selected surfaces from paint. By environmentally acceptable is meant a composition that is water-based and water-washable. As such, alcohols and other volatile organic chemicals (VOC's) are not required in the composition, which makes it not only non-flammable, but also less harmful to the air and to the user. The composition may optionally include other water soluble film forming compounds.

Compounds of this type are largely employed in the automotive repair industry where the vehicle is painted, entirely or as to selected surfaces. In lieu of the time-consuming step of masking with paper, the masking compound is applied to those surfaces where paint is not desired and the vehicle is subsequently painted and may be baked to dry and cure the finish. Afterwards, a simple washing step removes the masking compound.

The composition of the present invention provides greater ease of removal of the film after use compared to previous compounds of this type. The composition of the present invention does not require the use of alcohols or other VOC's as solvents. Accordingly, when such compounds are not present, shipping and storage requirements are less stringent; the user is not required to wear a respirator; there is no objectionable solvent odor, and objectionable solvents and VOC's are not released into the air. Additionally, when such solvents are absent, the composition carries a significantly lower risk of staining (blushing) the paint onto which it may be applied. However, alcohols may be added to quicken drying of the film. Additionally, alcohol may be added to the composition as a result of using an alcohol dispersion of PVP as a stock reagent for the composition of the present invention. Dispersions of PVP in ethanol are commercially available, for example. When alcohols are present, there is an increased risk of staining of the paint onto which it is applied, as well as more stringent shipping, storage and handling requirements.

As is known, liquid masking compounds are based on a film-forming compound which applies as a liquid and then readily dries to form a protective film. The film-forming composition of the present invention contains PVP at a concentration of about 2 to about 50 percent by weight. Suitable grades of PVP are available from International Specialty Products of Wayne, N.J. Such grades include: K-15, having a molecular weight range of about 6,000 to about 15,000; K-30, having a molecularweight range of about 40,000 to about 80,000; K-60, having a molecular weight range of about 240,000 to about 450,000; K-90, having a molecular weight range of about 900,000 to about 1,500,000; and K-120, having a molecular weight range of about 2,000,000 to about 3,000,000. Mixtures of PVP's can be employed, as can combinations of PVP and other film-forming compounds.

The amount and molecular weight distribution of the PVP used will influence the viscosity, coverage, and cost of the final product. The viscosity should preferably be between about 20 to 200 centipoise, more preferably between about 20 to 100 centipoise, even more preferably between about 30 and about 80 centipoise, and most preferably between about 35 and about 55 centipoise. Typically, lower molecular weight PVP will give a less viscous product than a higher molecular weight PVP at the same concentration. For a given concentration of PVP, as the molecular weight range increases, the viscosity will also increase. The present invention may employ PVP having any of a number of molecular weight ranges. For example, masking compositions may utilize the PVP grades K-15, K-30, K-60, K-90, or K-120 described above. It is preferred, however, to use PVP with a molecular weight distribution between about 200,000 and about 500,000. PVP having this molecular weight distribution typically gives a masking composition with a viscosity which can be easily adjusted and washes off a surface easily with no visible signs of interaction with a painted surface. In a preferred embodiment, PVP with a molecular weight distribution between about 200,000 and about 500,000 is present at a concentration of between about 3 and about 10 percent by weight. In another preferred embodiment, PVP with a molecular weight distribution between about 200,000 and about 500,000 is present at a concentration of between about 3.5 and about 7 percent by weight.

In addition to the PVP, the composition of the present invention also comprises a plasticizer. Polyhydroxyalcohols are preferred plasticizers with glycols and glycerine being more preferred and with glycerine being especially preferred. It is also envisioned that other plasticizers may also be used provided that they impart to the resulting film resistance to the particular solvent or solvents to which the film may be exposed, such as in a painting operation.

Glycerine, a trihydric alcohol, is a preferred plasticizer because it is practically insoluble in hydrocarbons and chlorinated solvents. While a film based solely on PVP will not be resistant to solvent-containing overspray, inclusion of glycerine will impart solvent resistance. If the glycerine level is too low, however, overspray can penetrate the film and attach to the painted surface that is intended to be protected. As the glycerine level increases, solvent resistance will also increase.

Inclusion of glycerine also allows the film to retain a slightly tacky surface feel. As the glycerine level increases, the resulting film will also exhibit an increasing degree of tackiness. Such tackiness is desirable at low levels in order to capture airborne particles of paint or other materials which could mar the finished product. If glycerine levels are too high, however, the film takes on the characteristics of a glycerin film, having a high tackiness and high solvent resistance, but also having low resistance to removal, by wiping, for example. Therefore, the ratio of PVP to plasticizer is preferably between about 0.5 to 1 to about 5 to 1, with a ratio of between about 1 to 1 and about 5 to 1 being more preferred.

The composition of the present invention may also contain one or more surfactants. While not wishing to condition patentability on any particular theory, it is believed that a surfactant will aid wetting of the surface to be covered and will aid even coverage by the film. The surfactant is also believed to aid foaming by the film when removed, thereby aiding removal of the film and washing of the protected surface. Suitable surfactants include nonionic, amphoteric and anionic species having a preferred hydrophilic-lipophilic balance (HLB) of from about 9 to about 14. Suitable surfactants include: amphoteric surfactants, such as Amphoteric N from Tomah Products; silicone surfactants, such as BYK 348 available from BYK Chemie; fluorinated surfactants such as Zonyl FS300 from DuPont Performance Chemical; and nonylphenoxypolyethoxyethanol based surfactants, such as Triton N-101 available from Dow. Other suitable surfactants include ethoxylated decynediols such as Surfynol 465 available from Air Products & Chemicals; alkylaryl polyethers such as Triton CF-10 available from Dow; octylphenoxy polyethoxy ethanols such as Triton X-100 available from Dow; ethoxylated alcohols such as Neodol 23-5 available from Shell; Tergitol 15-S-7 available from Dow, and Steol-4N, a 28% sodium laureth sulfate from Stepan Company. Amphoteric N and BYK 348 are preferred surfactants. The surfactant(s) are preferably present at a level of about 0.1 to 3 percent by weight. The important criteria for surfactant selection is good wetting ability, water solubility and low foam. Mixtures of surfactants may be employed.

The composition of the present invention may optionally comprise thickeners to aid application of the composition to the surface to be protected. Acceptable thickeners include polyacrylates, magnesium silicates, polyvinyl alcohol, fumed silicas, guar gum, and hydroxymethylcellulose. An example of a suitable thickener is the polyvinyl alcohol Elvanol 50-42N available from DuPont. It should be noted that the composition of the present invention is a PVP based film forming composition and is not based on the use of aliphatic polyols, such as polyvinyl alcohol. Therefore, it should be understood that when a polyvinyl alcohol is present, it is utilized only as a thickening agent and not as a base compound for film formation. In such cases, the polyvinyl alcohol is utilized at a concentration of up to 2.4 percent by weight, which is insufficient for forming an adequate film with a single application. Thickeners other than polyvinyl alcohol may be present at concentrations up to about 8 percent by weight. Thickener concentrations of between 0 and about 4 percent by weight are referred and concentrations between 0 and about 2 percent by weight are especially preferred.

Another preferred group of thickeners are polyacrylate thickeners such as the proprietary Acusol thickeners available from Rohm and Haas (Philadelphia, Pa.), and Carbopol thickeners available from B F Goodrich (Cleveland, Ohio). An especially preferred thickener is Acusol 823. When a polyacrylate thickener is used, it may be used at concentrations of up to about 3 percent of the masking compound by weight. Mixtures of thickening agents can also be employed, in which instance the total amount can be up to about 3 percent, depending on the thickeners used and the desired viscosity of the final product.

Acusol 823 is a proprietary polyacrylate thickener. This thickener is an associative acrylic copolymer typically used in detergents and liquid cleaners. It is a high efficiency, shear thinning thickener which provides good vertical cling. It is anionic and is compatible with surfactants.

Carbopol 934 is a polyacrylate thickener sold by B F Goodrich. The manufacturer's Material Safety Data Sheet indicates that this product is predominantly an acrylic polymer having CAS Number 0009003-01-4. Another polyacrylate thickener is sold by B F Goodrich under the tradename Carbopol Aqua-30 Polymer. This thickener is described only as an aqueous acrylate emulsion having a proprietary composition.

Still other thickeners which maybe used include dextrin, cornstarch and hydrous magnesium silicates, such as sodium magnesium silicate sold under the trade name Laponite XLG by Southern Clay Products, Inc.

The composition of the present invention may also include various supplemental ingredients such as saccharides. When one or more saccharides are present in the composition, however, in order to avoid the disadvantages associated with the use of saccharides as described above, the total saccharide concentration is than 16 percent by weight. Preferably, the saccharide concentration is less than 15 percent by weight and more preferably, 10 percent by weight or less. Most preferably, the composition is substantially devoid of saccharides. Therefore, the composition of the present invention may include one or more saccharides with the proviso that when a saccharide is present, it is present at a weight percentage of less than 16 percent.

In addition to the foregoing components, the composition of the present invention may also comprise one or more performance enhancing additives. These include flash rust inhibitors, which include any of a number of organic or inorganic materials used in a water-based system to prevent rust from forming on contact with the material and bare metal. One example is sodium benzoate.

Another optional performance enhancing additive is any of an array of defoamers recommended for water-based systems, to prevent unwanted foaming of the product during application. Too much foam can disrupt the required continuous film formation of the product and result in product failure. It may also be advantageous to add a foam control product, to aid in mixing and processing the masking composition, such as Drewplus L475 from Ashland Chemical, Inc., Drew Industrial Division.

Other possible additives include fragrances. However, inasmuch as this product contains no odorous solvents, a fragrance is not as necessary in the present invention as in other similar products on the market. However, a small amount may be added. Biocides may also be added to help protect the product from bacterial attack during storage for extended periods. An example of an acceptable biocide is the bacteriocide sold under the tradename Troysan 174 manufactured by Troy Corporation of Florham Park, N.J. Finally, color may be added as an optional component for aesthetic value and to aid in identifying areas where the product has been applied. Small amounts (typically less than 1 percent by weight) of these additional materials may be added with an appropriate adjustment of the water or other components. It is to be understood that mixtures of any one or more of the foregoing optional components can also be employed.

In order to prepare compositions of the present invention, a polyvinylpyrrolidone solution or polyvinylpyrrolidone solid is added to water with mixing. The composition of the present invention is easier to manufacture than prior compositions because there is no requirement for heating as with similar polyvinyl alcohol products on the market. The remaining ingredients are then added with mixing (e.g., plasticizer, surfactant, thickener, flash rust inhibitor, defoamer, color, fragrance and the like) with a thickener, if present, being added last. Mixing is generally continued for approximately 30 minutes or until the composition is smooth.

The composition of the present invention is employed by applying in a convenient manner such as, for example, by brushing, rolling, spraying or the like. Generally, it is allowed to set or dry for about 5 to about 30 minutes in order to form the film. The drying time will be at least partially dependent on the environmental conditions such as humidity, for example. The composition of the present invention is preferably formulated to remain slightly tacky after forming the film in order to trap and retain airborne dust but not so tacky as to prevent tape adhesion in those applications where the masking composition is used in conjunction with masking with paper.

As an example of such a use, an area approximately 18 inches wide around the area to be painted is masked off with paper and tape following application of the masking compound. The vehicle can then be painted and baked or otherwise suitably dried. When the paint is adequately dried, depending upon the type of paint, atmospheric conditions, and specifications of the manufacturer, the small perimeter of paper is removed and then the masking film is removed by the application of water to the surfaces. Washing is generally effected under pressure alone, although certain areas where paint has built-up heavily may require hand pressure with a towel or sponge and possibly the use of a brush.

The composition of the present invention may remain on the surfaces for an extended period of time. Typically, when used as a paint masking compound, the composition of the present invention will remain on the surfaces for about one-half to about 48 hours, which is more than adequate for all the work to be completed. Depending on its use, however, the composition may be allowed to remain on the surface for a longer period of time. No upper time limit is known for this composition to be allowed to remain on the surfaces.

A method of the present invention is practiced by applying a liquid masking composition to selected surfaces of an object where paint, subsequently applied, is not desired. As noted hereinabove, such application can be done in a variety of suitable manners such as spraying, brushing, rolling or the like. Next, the liquid masking composition is allowed to dry, forming a film. This step can be controlled somewhat by formulation of the composition; however, for practical uses, a time of from about 20 to about 30 minutes is sufficient. Next, the paint is applied to the object to be painted and the paint is allowed to dry. Finally, the method concludes by removing the film, simply by washing.

Similarly, the composition of the present invention may also be used in another method to prevent the deposition of dirt, oil, grease, tar, asphalt, acid rain, air pollutants, soot, vehicle exhaust, or other contaminants on surfaces of goods during their shipment or use. As mentioned above, the liquid masking composition is applied to the surface such as by spraying, brushing, rolling or the like, and then permitted to dry. After the goods are shipped or used, the film is removed by washing. Additionally, the composition of the present invention is more readily removed from rubber and plastic surfaces, as well as painted surfaces, than similar products currently on the market.

As an example, a composition according to the present invention was prepared as follows, with all percentages being by weight percent unless otherwise noted. A 4.5 weight percent PVP composition was made by charging 84.289 weight percent water and 10 percent PVP solution (45 percent by weight, PVP K-60) into a suitable mixer. Mixing proceeded at room temperature for several minutes until the mixture was homogeneous. The following materials were then added in order and mixed until the composition was smooth: glycerine, 2.6 percent; Amphoteric N, 1.5 percent; BYK 348, 0.3 percent; fragrance, 0.03 percent; pigment, 0.007 percent; TROYSAN 174, 0.1 percent; DREWPLUS L475, 0.13 percent; and ACUSOL 823, 1.044 percent. The composition was mixed for about 30 minutes. The resulting composition was applied to a test surface by spraying and allowed to dry for about 20 to 30 minutes. The resulting film was slightly tacky and was tested for protection of the underlying surface by overspraying with paint. The paint was allowed to dry and the test surface was baked at about 150° F. (66° C.) for about 30 minutes. The film and overspray were removed by washing with water. The resulting film displayed resistance to overspray and was easily removed by washing.

A series of compositions according to the present invention were also prepared and tested as described above, except as noted below. The samples contained the components listed in Table 1. PVP K-60 was supplied as a 45 percent solution in water and was added to water as described above. PVP K-15, PVP K-30, PVP K-90, and PVP K-120 were provided as solids which were dissolved in water prior to addition of the other components. The values listed in Table 1 are expressed as percentages of the final composition by weight. Each sample contained sufficient water to total 100 percent by weight.

TABLE 1
Masking Compositions Based on PVP of Varying Molecular Weight

| | Sample A | Sample B | Sample C | Sample D | Sample E |
|---|---|---|---|---|---|
| | (PVP | (PVP | (PVP | (PVP | (PVP |
| Component | K-15) | K-30) | K-60) | K-90) | K-120) |
| PVP | 5.175 | 5.175 | 5 | 5 | 5 |
| Glycerin | 1.5 | 1.5 | 1 | 1 | 1 |
| Amphoteric | 1.5 | 1.5 | — | — | — |
| N | | | | | |
| Triton N-101 | — | — | 1 | 1 | 1 |
| BYK 348 | 0.4 | 0.4 | 0.5 | 0.5 | 0.5 |
| Acusol 823 | 1.5 | 1.5 | — | — | — |

While the formulations listed in Table 1 displayed a range of viscosities, each sample displayed adequate protection of a surface from overspray.

Additional samples, based on differing grades and amounts of PVP, were made and tested for protection of a surface from overspray as described above. The composition of each of the samples is listed in Table 2. The values listed in Table 2 are expressed as percentages by weight. Each sample contained sufficient water to total 100 percent by weight. Both of these samples provided the test surface with protection from paint overspray.

TABLE 2
Masking Compositions Based on Varying Molecular Weight and
Amount of PVP

| | Sample F | Sample G |
|---|---|---|
| Component | (PVP K-60) | (PVP K-120) |
| PVP | 9 | 2.5 |
| Glycerin | 2 | 1 |
| Amphoteric N | 3 | — |
| Triton N-101 | 1 | 0.5 |
| BYK 348 | 0.5 | 0.15 |

Additional samples, containing differing amounts of glycerin, were made and tested for protection of a surface from overspray as described above. The composition of each of the samples is listed in Table 3. Each sample in Table 3 contained PVP K-60. The values listed in Table 3 are expressed as percentages by weight. Each sample contained sufficient water to total 100 percent by weight.

TABLE 3
Masking Compositions Based on Varying Amounts of Glycerin
(PVP K-60)

| Component | Sample H | Sample I | Sample J | Sample K | Sample L |
|---|---|---|---|---|---|
| PVP | 5 | 5.175 | 5.175 | 5.175 | 5.175 |
| Glycerin | 1 | 2 | 2.45 | 3.43 | 4.37 |
| Amphoteric | — | 3 | 3 | 3 | 3 |
| N | | | | | |
| Triton N-101 | 1 | — | — | — | — |
| BYK 348 | 0.5 | 0.5 | 0.5 | 0.5 | 0.5 |

All of the formulations listed in Table 3 produced films which displayed a generally acceptable amount of overspray protection. There were some indications of a decrease in overspray protection for Sample H. Namely, the film and overspray were not uniformly removed with a simple washing but required additional physical pressure, as by rubbing with a cloth or brush, for example. The resulting film did protect the underlying surface, however. Additionally, while the film made from Sample L displayed good overspray resistance, it also displayed relatively high surface tack.

A series of formulations containing varying amounts of PVP K-90, glycerin, and surfactants were made and tested for protection of a surface from overspray as described above. The composition of each of the samples is listed in Table 4. The values listed in Table 4 are expressed as percentages by weight. Each sample contained sufficient water to total 100 percent by weight.

TABLE 4
Masking Compositions Based on Varying Amounts of Surfactants
(PVP K-90)

| | Sample | Sample | Sample | Sample | Sample | Sample |
|---|---|---|---|---|---|---|
| Component | M | N | O | P | Q | R |
| PVP | 5 | 5 | 5 | 4 | 2.5 | 2.5 |
| Glycerin | 4 | 3 | 2 | 2 | 1 | 1 |
| Amphoteric N | — | 3 | — | — | — | — |
| Triton N-101 | 1 | 1 | 1 | 1 | 0.5 | 0.5 |
| BYK 348 | 0.5 | 0.5 | 0.5 | 0.3 | 0.5 | 0.15 |
| Steol-4N | — | 3 | — | — | — | — |

Films made from Samples M-R all displayed adequate protection from paint overspray. The film made from Sample N displayed a high level of tackiness compared to films made from other samples.

Thus, it should be evident that the composition and methods of the present invention are highly effective in masking surfaces with a water-washable film-forming composition. The invention is particularly suited for painting and shipping of motor vehicles, but is not necessarily limited thereto, as it can be applied to virtually any surface that requires protection from adjacent painting operations or possible deposition of contaminating materials, and which can be subsequently washed or otherwise treated with water to dissolve and wash away the film. The composition and method of the present invention can be employed with a variety of application equipment, methods and the like. Furthermore, because the composition can be free of alcohols and other solvents other than water, it can be essentially harmless to the environment.

Based upon the foregoing disclosure, it should now be apparent that the use of the liquid masking composition described herein will carry out the objects set forth hereinabove. It is, therefore, to be understood that any variations evident fall within the scope of the claimed invention and thus, the selection of specific component elements can be determined without departing from the spirit of the invention herein disclosed and described. In particular, compositions according to the present invention are not necessarily limited to those using International Specialty Products PVP K-60 as the PVP, or to the specific plasticizers, surfactants, or thickeners disclosed herein. Thus, the scope of the invention shall include all modifications and variations that may fall within the scope of the attached claims.

What is claimed is:

1. A liquid masking composition comprising:
from about 2 to about 50 percent by weight of polyvinylpyrrolidone;
a water soluble plasticizer at a polyvinylpyrrolidone to plasticizer ratio of between about 0.5 to 1 to about 5 to 1;
from 0 to about 8 percent by weight of at least one surfactant;
from 0 to less than 16 percent by weight of a saccharide; and
sufficient water to total 100 percent by weight.

2. A liquid masking composition, as set forth in claim 1, wherein said plasticizer is selected from the group consisting of polyhydroxyalcohols.

3. A liquid masking composition, as set forth in claim 2, wherein said plasticizer is glycerine.

4. A liquid masking composition, as set forth in claim 1, wherein said polyvinylpyrrolidone has a molecular weight distribution between about 200,000 and about 500,000.

5. A liquid masking composition, as set forth in claim 4, wherein said liquid masking composition comprises from about 3 to about 10 percent by weight polyvinylpyrrolidone.

6. A liquid masking composition, as set forth in claim 1, wherein said surfactant is selected from the group consisting of nonionic, amphoteric and anionic surfactants having a hydrophilic-lipophilic value of about 9 to 14.

7. A liquid masking composition, as set forth in claim 6, wherein said surfactant is selected from the group consisting of amphoteric surfactants, silicone surfactants, and mixtures thereof.

8. A liquid masking composition, as set forth in claim 1, further comprising at least one thickening agent selected from the group consisting of polyacrylates, magnesium silicates, polyvinyl alcohol, fumed silicas, guar gum, and hydroxymethylcellulose.

9. A liquid masking composition, as set forth in claim 8, wherein said at least one thickening agent is present in an amount up to about 8 percent by weight with the proviso that polyvinyl alcohol may be present in an amount up to 2.4 percent by weight.

10. A liquid masking composition, as set forth in claim 9, wherein said at least one thickening agent is a polyacrylate.

11. A liquid masking composition, as set forth in claim 1, wherein said plasticizer is glycerine, said surfactant is at least one compound selected from the group consisting of silicone surfactants, amphoteric surfactants, and mixtures thereof, and additionally comprising a polyacrylate thickener in an amount up to about 2 percent by weight.

12. A method for protecting selected surfaces from paint in painting operations comprising:
applying a liquid masking composition to selected surfaces of an object where paint subsequently applied is not desired;
allowing said liquid masking composition to dry, forming a film;
painting said object, whereby surfaces carrying said film are protected from the application of paint; and
removing said film, wherein said liquid masking composition comprises:
from about 2 to about 50 percent by weight of polyvinylpyrrolidone;
a water soluble plasticizer at a polyvinylpyrrolidone to plasticizer ratio of between about 0.5 to 1 to about 5 to 1;
from 0 to about 8 percent by weight of at least one surfactant;
from 0 to less than 16 percent by weight of a saccharide; and
sufficient water to total 100 percent by weight.

13. A method for protecting selected surfaces from paint, as set forth in claim 12, wherein said plasticizer is selected from the group consisting of polyhydroxyalcohols.

14. A method for protecting selected surfaces from paint, as set forth in claim 13, wherein said plasticizer is glycerine.

15. A method for protecting selected surfaces from paint, as set forth in claim 12, wherein said surfactant is selected from the group consisting of nonionic, amphoteric and anionic surfactant having a hydrophilic-lipophilic value of about 9 to 14.

16. A method for protecting surfaces from paint, as set forth in claim 15, wherein said surfactant is selected from the group consisting of amphoteric surfactants, silicone surfactants, and mixtures thereof.

17. A method of protecting selected surfaces from paint, as set forth in claim 12, wherein the liquid masking composition further comprises at least one thickening agent selected from the group consisting of polyacrylates, magnesium silicates, polyvinyl alcohol, fumed silicas, guar gum, and hydroxymethylcellulose.

18. A method for protecting selected surfaces from paint, as set forth in claim 17, wherein said at least one thickening agent is present in an amount up to about 8 percent by weight, with the proviso that polyvinyl alcohol may be present in an amount up to 2.4 percent by weight.

19. A method for protecting selected surfaces from paint, as set forth in claim 18, wherein said at least one thickening agent is a polyacrylate.

20. A method for protecting selected surfaces from paint, as set forth in claim 12, wherein said liquid masking composition further comprises:
from about 3 to about 10 percent by weight of said polyvinylpyrrolidone;
from about 1 to about 10 percent by weight of glycerine;
from 0 to about 2 percent by weight of a polyacrylate thickening agent;
from about 0.5 to about 2 percent by weight of an amphoteric surfactant;
from about 0.1 to about 1 percent by weight of a silicone surfactant; and
sufficient water to total 100 percent by weight.

21. A method for protecting selected surfaces of goods from the deposition of dirt, oil, grease, air pollutants, acid rain, vehicle exhaust, soot, rubber or asphalt pieces, road tar, or other contaminants, comprising:
applying a liquid masking composition to selected surfaces of a good to be protected;
allowing said liquid masking composition to dry, forming a film;
exposing said object to potential contamination, whereby surfaces carrying said film are protected from the deposition of dirt, oil, grease, air pollutants, acid rain, vehicle exhaust, soot, rubber or asphalt pieces, road tar, or other contaminants; and
removing said film,
wherein said liquid masking composition comprises:
from about 2 to about 50 percent by weight of polyvinylpyrrolidone;
a water soluble plasticizer at a polyvinylpyrrolidone to plasticizer ratio of between about 0.5 to 1 to about 5 to 1;
from 0 to about 8 percent by weight of at least one surfactant;
from 0 to less than 16 percent by weight of a saccharide; and
sufficient water to total 100 percent by weight.

22. The method for protecting surfaces of goods of claim 21, wherein said plasticizer is selected from the group consisting of polyhydroxyalcohols.

23. The method for protecting surfaces of goods of claim 22, wherein said plasticizer is glycerine.

24. The method of protecting surfaces of goods of claim 21, wherein said liquid masking compound further comprises at least one thickening agent selected from the group consisting of polyacrylates, magnesium silicates, polyvinyl alcohol, fumed silicas, guar gum, and hydroxymethylcellulose.

25. The method for protecting surfaces of goods of claim 21, wherein said surfactant is selected from the group consisting of nonionic, amphoteric and anionic surfactant having a hydrophilic-lipophilic value of about 9 to 14.

26. The method for protecting surfaces of goods of claim 25, wherein said surfactant is selected from the group consisting of amphoteric surfactants, silicone surfactants and mixtures thereof.

27. The method for protecting surfaces of goods of claim 21, wherein said liquid masking composition further comprises:
from about 3 to about 10 percent by weight of said polyvinylpyrrolidone;
from about 1 to about 10 percent by weight of glycerine;
from 0 to about 2 percent by weight of a polyacrylate thickening agent;
from about 0.5 to about 2 percent by weight of an amphoteric surfactant;
from about 0.1 to about 1 percent by weight of a silicone surfactant; and
sufficient water to total 100 percent by weight.

28. The method for protecting surfaces of goods of claim 21, wherein the goods to be protected are motor vehicles.
